(19) United States
(12) Patent Application Publication
(10) Pub. No.: US 2024/0326193 A1
(43) Pub. Date: Oct. 3, 2024

(54) NUMERICAL CONTROL TOOL HOLDER, ROTARY BODY DYNAMIC BALANCE DETECTION AND CORRECTION DEVICE, AND METHOD

(71) Applicant: FUZHUN PRECISION TOOLING (JIASHAN) CO., LTD., Jiaxing (CN)

(72) Inventors: LIN-FEI QIU, Kunshan (CN); XIAN-QIAN ZENG, Kunshan (CN); YU XIA, Kunshan (CN); DA-WEI LI, Kunshan (CN); JIAN-GUANG GAO, Kunshan (CN)

(21) Appl. No.: 18/574,915

(22) PCT Filed: Sep. 7, 2021
(86) PCT No.: PCT/CN2021/116833

§ 371 Date: Jun. 21, 2024

(51) Int. Cl. B23Q 15/14; G01M 1/34

(52) U.S. Cl. CPC B23Q 15/14; G01M 1/34

(57) ABSTRACT

A rotary body dynamic balance detection and correction device, comprising a detection assembly and a machining correction assembly. The detection assembly is configured to detect the amount of unbalance of a rotary body. The machining correction assembly is configured to machine an outer peripheral face of the rotary body to form a correction hole, so that the value of the amount of unbalance of the machined rotary body does not exceed the value of a preset maximum amount of unbalance. The rotary body dynamic balance detection and correction device can effectively correct the amount of unbalance of the rotary body, reduce the degree of unbalance of the rotary body, and avoid excessive lateral vibration generated when the rotary body rotates at a high speed. A rotary body dynamic balance detection and correction method and a numerical control tool holder are also provided.

### FIELD

The present disclosure relates to technical field of dynamic balance of rotary body, especially relates to a numerical control tool holder, rotary body dynamic balance detection and correction device, and method.

### BACKGROUND

In computer numerical control machining (CNC machining), the tool holder drives the machining tool to rotate at high speed to machine a workpiece. In practice, the machining tool rotates in high-speed, transverse vibration of the tool is generated due to imbalance of the tool, thereby reducing the machining accuracy of the workpiece. Other rotating bodies also have the problem of transverse vibration when rotating at high speed.

### SUMMARY

The present application provides a numerical control tool holder, a rotary body dynamic balance detection and correction device and method to solve the above problems.

Embodiments of the present application are achieved in this way:

A rotary body dynamic balance detection and correction device, including a detection assembly and a machining correction assembly. The detection assembly is configured for detecting an amount of unbalance of a rotary body. The machining correction assembly is configured for machining and forming a correction hole on an outer peripheral surface of the rotary body, to make a value of the amount of unbalance of the machined rotary body do not exceed a predetermined value of a maximum amount of unbalance.

In one embodiment, the rotary body is a numerical control tool holder. The detection assembly includes an imitation computer numerical control (CNC) machine tool spindle. The imitation CNC machine tool spindle having a locking cylinder for clamping the numerical control tool holder. A dynamic balance measuring instrument is provided on the imitation CNC machine tool spindle. The dynamic balance measuring instrument is capable of measuring the amount of unbalance of the numerical control tool holder when the spindle drives the numerical control tool holder to rotate. The imitation CNC machine tool spindle may be a spindle formed by machining the shape of an actual CNC machine tool spindle.

In one embodiment, an internal structure of the imitation CNC machine tool spindle is symmetrical to minimize the unbalance error of the rotating portion.

In one embodiment, the dynamic balance measuring instrument includes a annular magnetic strip and a magnetic scale. The spindle is driven to rotate through a synchronous belt. The annular magnetic strip and the magnetic scale are configured for recording a real-time position of the tool holder, thereby improving the measured positional accuracy.

In one embodiment, the machining correction assembly includes a machining head, a head displacement assembly, and a tool setting assembly. The machining head is mounted to the head displacement assembly, and the machining head is capable of being moved by the head displacement assembly to a position to be machined, the position locates at a peripheral surface of a numerical control tool holder clamped to the locking cylinder and corresponds to the machining head. The tool setting assembly is configured for a tool setting of the machining head.

In one embodiment, the tool setting assembly includes a tool setting moving assembly and a tool setting instrument mounted to the tool setting moving assembly. The tool setting instrument is capable of being moved relative to the machining head driven by the tool setting moving assembly to perform a tool setting operation.

In one embodiment, the machining correction assembly further includes a tool holder clamping assembly. The tool holder clamping assembly is configured for clamping the numerical control tool holder to limit a rotation of the numerical control tool holder.

Embodiments of the present application also provide a method of dynamic balance detection and correction of a rotary body. The method includes: detecting a dynamic balance of the rotary body, to obtain an initial amount of unbalance \vec{U₀} of the rotary body; machining the rotary body for correction, machining a correction hole in a peripheral surface of the rotary body, and a value of the amount of unbalance of the rotary body after machining of the correction hole does not exceed a value of a predetermined maximum amount of unbalance.

In one embodiment, the peripheral surface of the rotary body includes a non-machinable angle range and a machinable angle range. When the initial amount of unbalance \vec{U₀} is in the non-machinable angle range of the rotary body, N correction holes are machined in the machinable angle range of the rotary body. A vector sum of N amounts of unbalance \vec{U} corresponding to N correction holes is equal to the initial amount of unbalance \vec{U₀}. N is an integer greater than or equal to 2. When the initial amount of unbalance \vec{U₀} is in the machinable range of the rotary body, one correction hole is machined on the rotary body according to the value and direction of the initial amount of unbalance \vec{U₀}.

In one embodiment, the rotary body is the numerical control tool holder, a limiting groove is defined on a peripheral surface of the numerical control tool holder, the limiting groove is configured for rotatable mounting of the numerical control tool holder, a bottom surface of the limiting groove being a reference plane;

The correction holes are formed by drilling inwardly along a radial direction of the numerical control tool holder by means of a ball drill bit, the process of forming the correction holes includes: determining a drilling depth h and a drilling angle θ of each correction hole according to a radius r₀ of the ball drill bit and an amount of unbalance \vec{U} corresponding to each correction hole;

For a correction hole formed by drilling from a reference plane, the drilling angle θ is equal to the angle of the corresponding amount of unbalance \vec{U} of that correction hole, and the drilling depth h is calculated by the following formula:

$$\{ \begin{matrix}R = \frac{L}{cos θ} \\ B = 4 {r}_{0} + 12 R \\ C = {r}_{0} ( {r}_{0} + 4 R ) \\ k = \frac{ρπ {r}_{0}^{2}}{12} \\ h = \frac{B - \sqrt{{B}^{2} - 24 ( C + U / k )}}{12}\end{matrix}$$

wherein L is a distance from a axis center of the numerical control tool holder to the reference plane, r₀ is a radius of the drill bit, R is a distance from the axis center of the numerical control tool holder to an intersection of a radial line along the angle θ and through the axis center of the numerical control tool holder and the reference plane, ρ is a density of the material of the numerical control tool holder, and U is a value of the amount of the unbalance \vec{U} corresponding to the correction hole.

In one embodiment, N=2, the two corresponding amounts of unbalance \vec{U} are \vec{U₁} and \vec{U₂}, and both are respectively located on two sides of the initial amount of unbalance \vec{U₀};

Setting an angle θ₁ between the amount of unbalance \vec{U₁} and the initial amount of unbalance \vec{U₀}, and setting an angle θ₂ between the amount of unbalance \vec{U₂} and the initial amount of unbalance \vec{U₀};

Determine the values of the amounts of unbalance \vec{U₁} and \vec{U₂} according to the following equations:

$$\{ \begin{matrix}{U}_{1} = \frac{{U}_{0} sin {θ}_{2}}{sin ( {θ}_{1} + {θ}_{2} )} \\ {U}_{2} = \frac{{U}_{0} sin {θ}_{1}}{sin ( {θ}_{1} + {θ}_{2} )}\end{matrix}$$

Wherein U₀ is the value of the amount of unbalance \vec{U₀}, U₁ is the value of the amount of unbalance \vec{U₁}, and U₂ is the value of the amount of unbalance \vec{U₂}.

In one embodiment, the defining way of the machinable angle range is: if the correction hole formed by drilling of the ball drill bit along the drilling angle θ and the limiting groove coincide completely or do not coincide at all, then the drilling angle θ is a machinable angle, and the set consisting of all the machinable angles constitutes the machinable angle range. The defining way of the non-machinable angle range is: a range outside the machinable angle range is a non-machinable angle range.

Embodiments of the present application also provide a numerical control tool holder including a tool holder body, a plurality of correction holes being provided in the tool holder body, and a plurality of the correction holes being processed by the rotary body dynamic balance detection and correction method.

### BRIEF DESCRIPTION OF THE DRAWINGS

In order to more clearly illustrate the technical solutions of the embodiments of the present application, the accompanying drawings in the embodiments will be briefly introduced below, and it should be understood that the following accompanying drawings only show certain embodiments of the present application, and therefore should not be regarded as a limitation of the scope, and that, for the person of ordinary skill in the field, other relevant accompanying drawings can be obtained based on the drawings without creative labor.

FIG. 1 is a perspective view illustrating a rotary body dynamic balance detection and correction device according to an embodiment of the present application.

FIG. 2 is a front view illustrating the rotary body dynamic balance detection and correction device in FIG. 1.

FIG. 3 is a schematic view illustrating a testing assembly according to an embodiment of the present application.

FIG. 4 is a cross-sectional view illustrating the testing assembly in FIG. 3.

FIG. 5 is a partial view illustrating a machining correction assembly in FIG. 1.

FIG. 6 is a perspective view illustrating a housing for setting up the rotary body dynamic balance detection and correction device in FIG. 1.

FIG. 7 is a flowchart illustrating a dynamic balance detection and correction method for a rotary body according to an embodiment of the present application.

FIG. 8 is a front view illustrating a numerical control tool holder as a rotary body.

FIG. 9 is a cross-sectional view illustrating the numerical control tool holder.

FIG. 10 is a view illustrating an aggregate relationship between the amounts of unbalance \vec{U₁} and \vec{U₂} and the initial amount of unbalance \vec{U₀}.

FIG. 11 is an auxiliary view illustrating a calculation method for obtaining the depth of a drilled hole from the amount of unbalance when drilling a hole from a reference plane to form a correction hole.

FIG. 12 is a schematic view illustrating a determination of a machinable angle range and a non-machinable angle range, in which the positions of the correction holes at the demarcation of the machinable angle range and the non-machinable angle range are shown by dashed lines.

FIG. 13 is a front view illustrating a numerical control tool holder after machining the correction holes.

Description of main components or elements:

| | |
|---|---|
| Rotary body | 10 |
| numerical control tool holder | 11 |
| outer peripheral surface | 12 |
| correction hole | 13 |
| took holder body | 14 |
| limiting groove | 15 |
| reference plane | 16 |
| machinable angle range | 17 |
| non-machinable angle range | 18 |
| rotary body dynamic balance detection and correction device | 20 |
| detection assembly | 21 |
| machining correction assembly | 22 |
| base | 23 |
| imitation CNC machine tool spindle | 24 |
| locking cylinder | 25 |
| dynamic balance measuring instrument | 26 |
| annular magnetic strip | 27 |
| magnetic scale | 28 |
| synchronous belt | 29 |
| drive motor | 30 |
| machining head | 31 |
| head displacement assembly | 32 |
| tool setting assembly | 33 |
| moving mechanism | 34 |
| horizontal bearing platform | 35 |
| handwheel | 36 |
| lead screw nut assembly | 37 |
| sliding guide | 38 |
| slide base | 39 |
| slide hole | 40 |
| machining tool | 41 |
| tool clamp | 42 |
| machining rotary motor | 43 |
| machining feed motor | 44 |
| tool setting moving assembly | 45 |
| tool setting instrument | 46 |
| horizontal cylinder | 47 |
| vertical cylinder | 48 |
| tool holder clamping assembly | 49 |
| clamping cylinder | 50 |
| clamping head | 51 |
| housing | 52 |

### DETAILED DESCRIPTION

The present disclosure will be further described in detail below in combination with the accompanying drawings.

In order to better understand the above objects, features and advantages of the disclosure, the disclosure is described in detail below in combination with the accompanying drawings and embodiments. It should be noted that the embodiments and features in the embodiments of the present application can be combined with each other without conflict.

Many specific details are set forth in the following description to facilitate a full understanding of the disclosure. The described embodiments are only some of the embodiments of the disclosure, not all of them. Based on the embodiments of the disclosure, all other embodiments obtained by those skilled in the art without creative work belong to the protective scope of the disclosure.

Unless otherwise defined, all technical and scientific terms used herein have the same meanings generally understood by those skilled in the technical field of the present disclosure. The terms used in the specification of the disclosure herein are only for the purpose of describing specific embodiments, and are not intended to limit the disclosure.

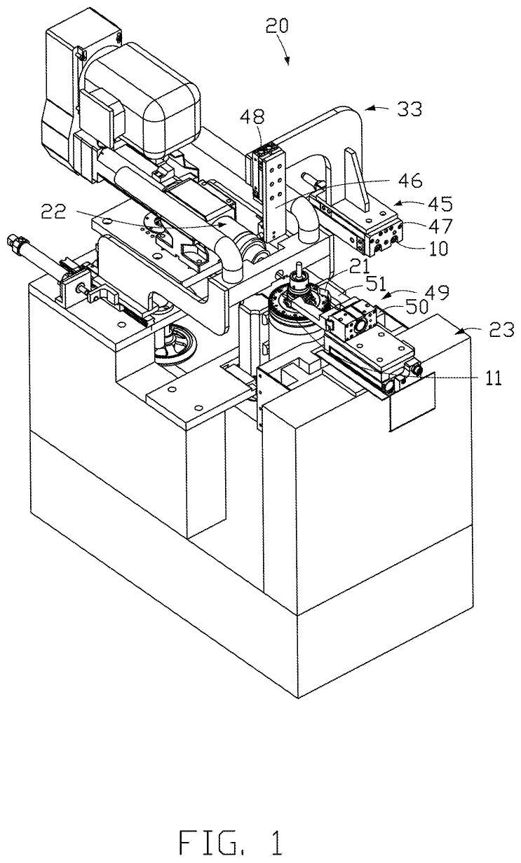

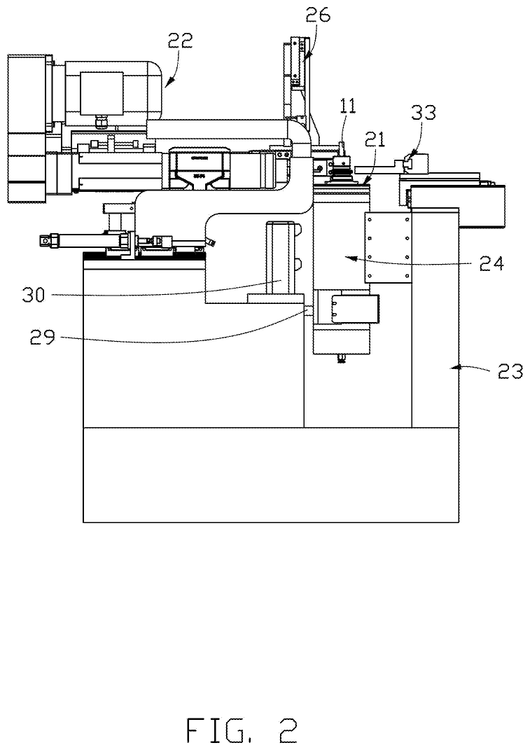

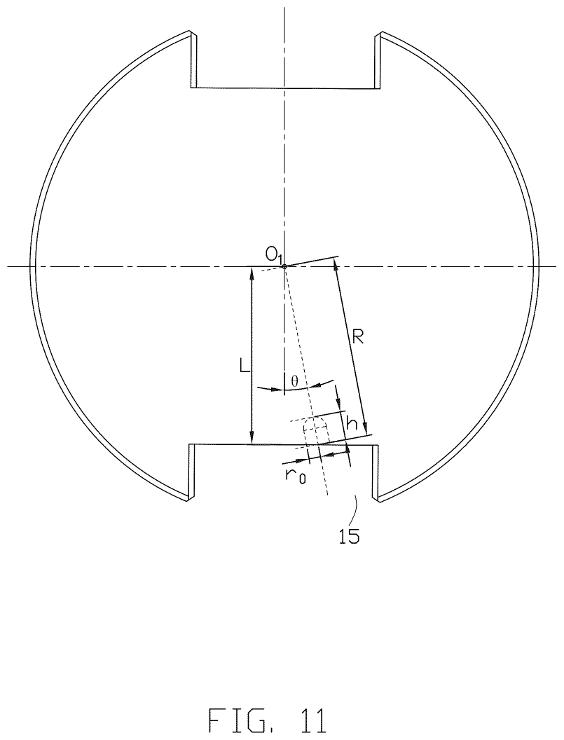

Referring to FIG. 1 and FIG. 2, one embodiment provides a rotary body dynamic balance detection and correction device 20, including a detection assembly 21 and a machining correction assembly 22. The detection assembly 21 is configured for detecting an amount of unbalance of the rotary body 10. The machining correction assembly 22 is configured to define one or more correction holes 13 (referring to FIG. 11) on an outer peripheral surface 12 of the rotary body 10, to make a value of the amount of unbalance of the machined rotary body 10 does not exceed a value of a predetermined maximum amount of unbalance. In one embodiment, the rotary body dynamic balance detection and correction device 20 further includes a base 23. The detection assembly 21 and the machining correction assembly 22 are respectively mounted on the base 23, forming a device having detection and correction functions.

In the present application, the term “rotary body” refers to an object that can rotate around its rotary axis, such as a numerical control tool holder configured to hold and rotate a tool in CNC machining.

The rotary body dynamic balance detection and correction device 20 in the present application corrects the amount of unbalance of the rotary body 10 by detecting the amount of unbalance and machining a correction hole 13 in the peripheral surface 12 of the rotary body 10, to reduce the amount of unbalance of the rotary body 10 and avoid excessive transverse vibration when the rotary body 10 rotates at a high speed.

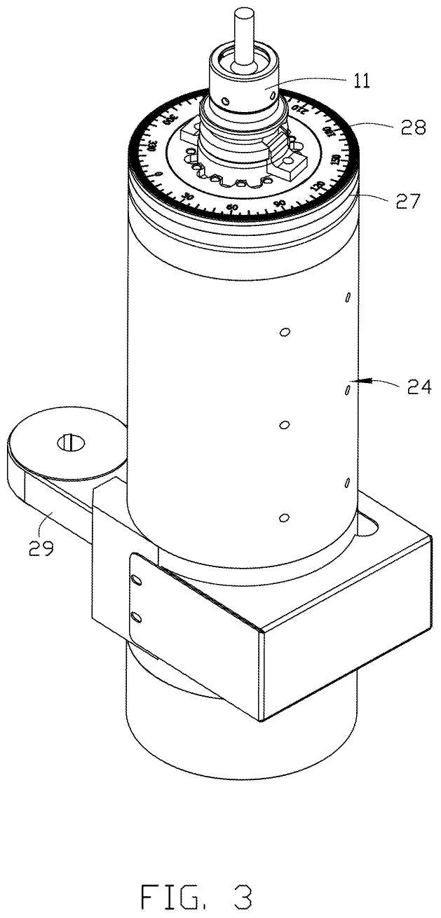

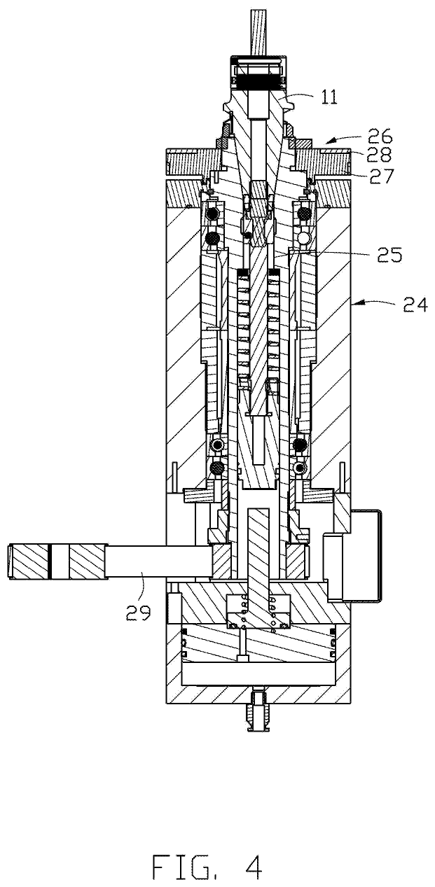

Referring to FIG. 3 and FIG. 4, in one embodiment, the rotary body 10 is a numerical control tool holder 11, and the device is a device for performing dynamic balance detection and correction of the numerical control tool holder 11. The detection assembly 21 includes an imitation CNC machine tool spindle 24, the imitation CNC machine tool spindle 24 having a locking cylinder 25 for clamping the numerical control tool holder 11. The imitation CNC machine tool spindle 24 is provided with a dynamic balance measuring instrument 26, and the dynamic balance measuring instrument 26 is capable of measuring the amount of unbalance of the numerical control tool holder 11 when the spindle drives the numerical control tool holder 11 to rotate. The imitation CNC machine tool spindle 24 in the present application refers to a spindle formed by machining a shape of an actual CNC machine tool spindle. In one embodiment, the internal structure of the imitation CNC machine tool spindle 24 is symmetrical to minimize unbalance error of rotating portion. The dynamic balance measuring instrument 26 may be a common dynamic balance measuring device, which is capable of obtaining angular position and value of the amount of unbalance of the numerical control tool holder 11 under test. In one embodiment, the dynamic balance measuring instrument 26 includes an annular magnetic strip 27 and a magnetic scale 28. In one embodiment, the spindle is driven by means of a synchronous belt 29, and a method of recording a real-time position of the tool holder 11 by means of the annular magnetic strip 27 and the magnetic scale 28 is able to improve the measured positional accuracy. In one embodiment, by simulating a real CNC machine tool spindle clamping the numerical control tool holder 11 for dynamic balance detection, the dynamic balance of the numerical control tool holder 11 in a real use state can be accurately obtained, and detected values are more reliable and effective.

In one embodiment, the imitation CNC machine tool spindle 24 is mounted vertically facing upward on the base 23, and the numerical control tool holder 11 is loaded into the locking cylinder 25 of the imitation CNC machine tool spindle 24 from an upper part. The base 23 is also provided with a drive motor 30, and the drive motor 30 rotates the numerical control tool holder 11 and the rotating portion of the spindle by means of a synchronous belt 29.

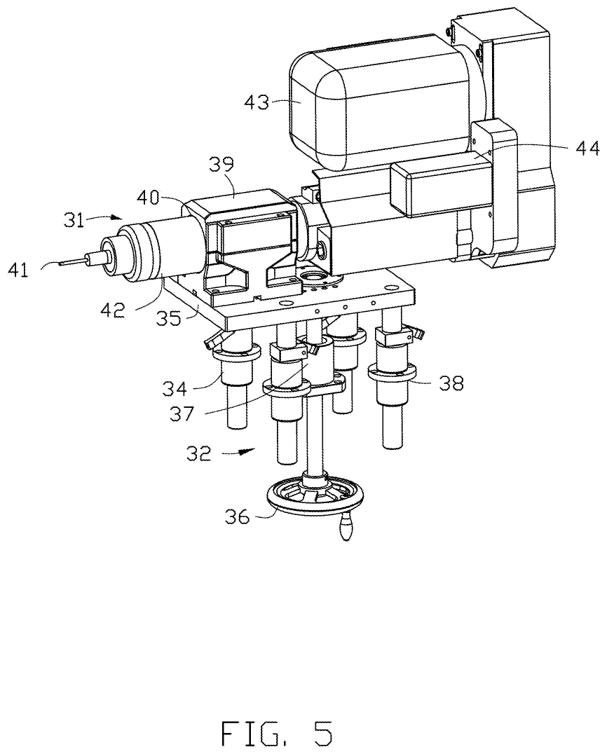

Referring to FIG. 5, in one embodiment, the machining correction assembly 22 includes a machining head 31, a head displacement assembly 32, and a tool setting assembly 33. The machining head 31 is mounted to the head displacement assembly 32 and is capable of being moved under the drive of the head displacement assembly 32 to a position to be machined, the position locates at the peripheral surface 12 of the numerical control tool holder 11 that is clamped to the locking cylinder 25 and corresponds to the machining head 31. The tool setting assembly 33 is configured for tool setting of the machining head 31.

The head displacement assembly 32 includes a moving mechanism 34. The moving mechanism 34 includes a horizontal bearing platform 35, a handwheel 36, a lead screw nut assembly 37, and a sliding guide 38. The horizontal bearing platform 35 is slidably fitted to the base 23 by the sliding guide 38. The handwheel 36 controls the lead screw nut assembly 37 to rotate, so that position of the horizontal bearing platform 35 can be adjusted up and down. The horizontal bearing platform 35 is provided with a slide base 39 having a slide hole 40 along the horizontal.

The machining head 31 includes a machining tool 41, a tool clamp 42, a machining rotary motor 43, and a machining feed motor 44. The machining tool 41 is provided in a horizontal direction and corresponds radially to an outer peripheral surface 12 of the numerical control tool holder 11, and the machining tool 41 is clamped in the tool clamp 42. The machining rotary motor 43 is drive-connected to the tool clamp 42 and rotates the machining tool 41 via the tool clamp 42. The machining feed motor 44 is drive-connected to the machining rotary motor 43 and is capable of driving the machining rotary motor 43, the tool clamp 42, and the machining tool 41 as a whole to move in a direction close to or away from the numerical control tool holder 11. Furthermore, the tool clamp 42 is slidably supported in the slide hole 40 of the slide base 39. In one embodiment, the axis of the machining tool 41 is perpendicular to the axis of the numerical control tool holder 11.

In one embodiment, the tool setting assembly 33 is configured for tool setting of the machining head 31. In one embodiment, the tool setting assembly 33 includes a tool setting moving assembly 45 and a tool setting instrument 46. The tool setting instrument 46 is mounted to the tool setting moving assembly 45. The tool setting instrument 46 can be driven by the tool setting moving assembly 45, so that the tool setting instrument 46 is capable of being moved relative to the machining head 31 to perform a tool setting operation. In one embodiment, the tool setting moving assembly 45 includes a horizontal cylinder 47 and a vertical cylinder 48. The tool setting instrument 46 is connected to the vertical cylinder 48. The tool setting instrument 46 can be moved vertically by the vertical cylinder 48. The horizontal cylinder 47 is fixedly mounted, and the horizontal cylinder 47 is drive-connected to the vertical cylinder 48 to move the vertical cylinder 48 and the tool setting instrument 46 in an axial direction of the machining tool 41. During tool setting operation, the horizontal cylinder 47 and the vertical cylinder 48 are extended to drive the tool setting instrument 46 to move to correspond to the machining tool 41, and then the machining feed motor 44 drives the machining tool 41 to move horizontally until the machining tool 41 encounters the tool setting instrument 46. Position data of the machining feed motor 44 is recorded, and then the horizontal cylinder 47 and the vertical cylinder 48 are retracted respectively, and the machining feed motor 44 is retracted to complete tool setting operation.

In one embodiment, the machining correction assembly 22 further includes a tool holder clamping assembly 49, the tool holder clamping assembly 49 is configured for clamping the numerical control tool holder 11 to limit self-rotation of the numerical control tool holder 11. In one embodiment, the tool holder clamping assembly 49 is mounted on the base 23, and the tool holder clamping assembly 49 includes a clamping cylinder 50 and a clamping head 51. The claiming head is connected to the clamping cylinder 50. The clamping head 51 can be closed to clamp the numerical control tool holder 11, thereby limiting self-rotation of the numerical control tool holder 11, so that the machining tool 41 can define the correction holes 13 on the numerical control tool holder 11.

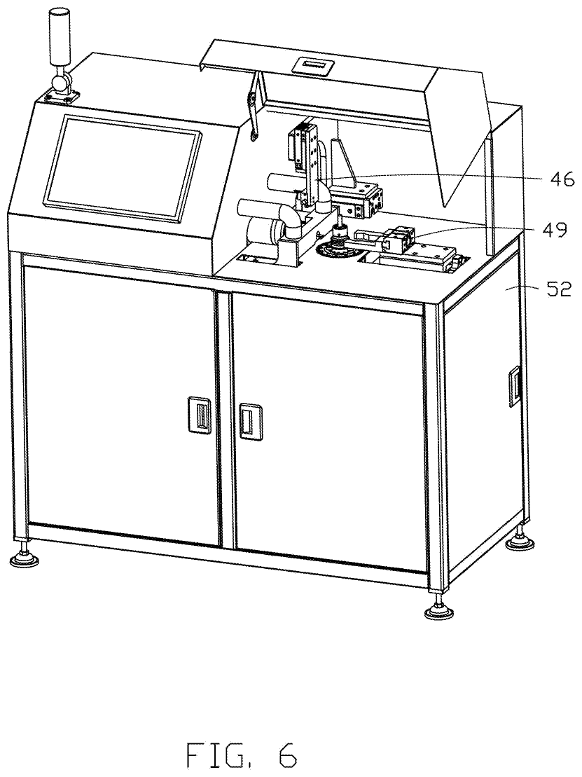

Referring to FIG. 6, in one embodiment, the rotary body dynamic balance detection and correction device 20 further includes a protective housing 52. The housing 52 is configured for covering moving structures of the device 20, to ensure safe use of the device or to avoid being interfered with by the outside environment. In one embodiment, part of the housing 52 may be provided with a movable cover, the cover can be opened and closed to facilitate observation or replacement of the numerical control tool holder 11.

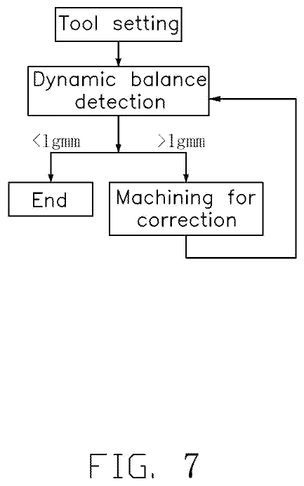

Referring to FIG. 7, embodiments of the present application also provide a rotary body dynamic balance detection and correction method based on the rotary body dynamic balance detection and correction device 20. The rotary body dynamic balance detection and correction method includes: detecting a dynamic balance of the rotary body 10, to obtain an initial amount of unbalance \vec{U₀} of the rotary body 10; machining the rotary body for correction. Specifically, machining a correction hole in the peripheral surface of the rotary body, and a value of the amount of unbalance of the rotary body after machining of the correction hole does not exceed a value of a predetermined maximum amount of unbalance.

After machining the correction hole 13 at one time, detecting whether the amount of unbalance meets the requirement of not exceeding the preset maximum amount of unbalance, and if it does, the correction process is completed; if it does not, the correction process is carried out again until the requirement is met. In one embodiment, the value of the preset maximum amount of unbalance may be set to 1 gmm.

In one embodiment, before machining the correction hole 13, tool setting operation can be applied on the machining tool 41 by the tool setting assembly 33. The dynamic balance detection and correction method of the rotary body of the present application corrects the amount of unbalance of the rotary body 10 by means of the detection of the amount of unbalance and the processing of the correction holes 13 in the outer peripheral surface 12 of the rotary body 10, reduces the degree of unbalance of the rotary body 10, and avoids excessive transverse vibration when the rotary body 10 rotates at a high speed.

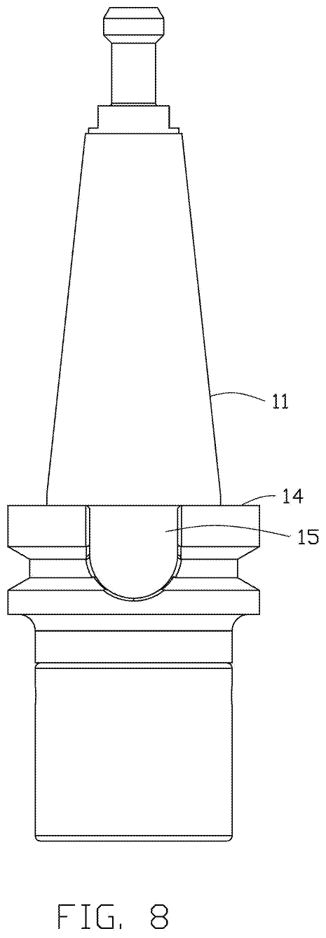

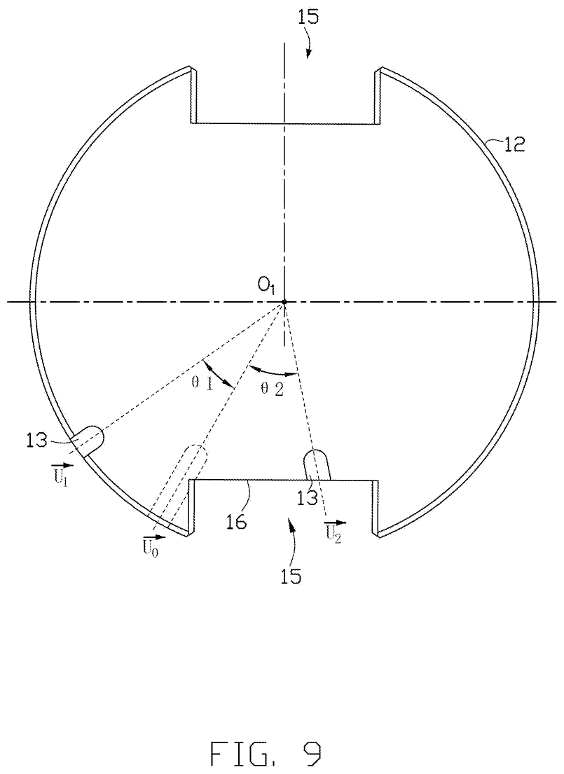

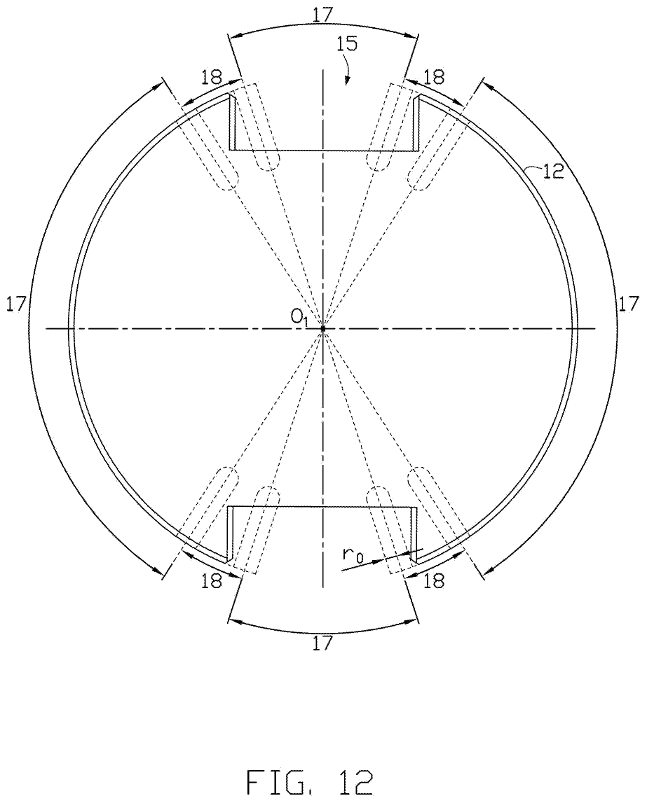

Referring to FIG. 8 and FIG. 9, in one embodiment, the rotary body 10 is a numerical control tool holder 11, and the peripheral surface 12 of the numerical control tool holder 11 is provided with one or more limiting grooves 15 for mounting of the numerical control tool holder 11. A bottom surface of the limiting groove 15 is a reference plane 16. The correction holes 13 are formed by drilling inwardly along a radial direction of the numerical control tool holder 11 by means of a ball drill bit. Referring to FIG. 12, a machinable angle range 17 is defined as follows: if the correction hole 13 formed by drilling of the ball drill bit along the drilling angle θ and the limiting groove 15 coincide or do not coincide at all, then the drilling angle θ is a machinable angle, and the set consisting of all machinable angles constitutes the machinable angle range 17. A non-machinable angle range 18 is defined as follows: a range outside the machinable angle range 17 is the non-machinable angle range 18.

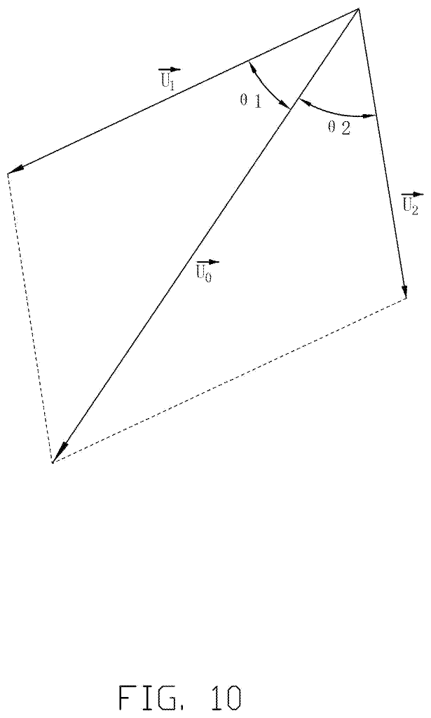

Referring to FIG. 9, FIG. 10, and FIG. 12, when the initial amount of unbalance \vec{U₀} is the non-machinable angle range 18 of the numerical control tool holder 11, N correction holes 13 are machined within the machinable angle range 17 of the numerical control tool holder 11. Vector sum of the N amounts of unbalance \vec{U} corresponding to the N correction holes 13 is equal to the initial amount of unbalance Measure \vec{U₀}. N is an integer greater than or equal to 2. When the initial amount of unbalance \vec{U₀} is in the machinable range 17 of the numerical control tool holder 11, one correction hole 13 is machined on the numerical control tool holder 11 according to the value and direction of the initial amount of unbalance \vec{U₀}.

Referring to FIG. 11, the step of machining the correction holes 13 includes: determining a drilling depth h and a drilling angle θ of each correction hole 13 based on a radius r₀ of the ball drill bit and amount of unbalance U corresponding to each correction hole 13. As for the correction hole 13 defined on the reference plane 16, the drilling angle θ is equal to an angle of the amount of unbalance \vec{U} corresponding to the correction hole 13. The drilling depth h is calculated by the following formula:

$$\{ \begin{matrix}R = \frac{L}{cos θ} \\ B = 4 {r}_{0} + 12 R \\ C = {r}_{0} ( {r}_{0} + 4 R ) \\ k = \frac{ρπ {r}_{0}^{2}}{12} \\ h = \frac{B - \sqrt{{B}^{2} - 24 ( C + U / k )}}{12}\end{matrix}$$

Wherein, L is a distance from a axis center O₁ of the numerical control tool holder 11 to the reference plane 16, r₀ is a radius of the drill bit, R is a distance from the axis center O₁ of the numerical control tool holder 11 to an intersection of a radial line along the angle θ and through the axis center O₁ of the numerical control tool holder 11 and the reference plane, ρ is a density of the material of the numerical control tool holder 11, and U is a value of the amount of the unbalance \vec{U} corresponding to the correction hole 13.

For the correction hole 13 defined from the curved section of the peripheral surface 12, the drilling angle θ is equal to the angle of the amount of unbalance \vec{U} corresponding to that correction hole 13, and the drilling depth h may be given by the detection assembly 21.

The detection assembly has a calculation part. The calculation part considers the numerical control tool holder 11 as a cylindrical shape without forming the limiting groove 15, and obtains a relationship between the amount of unbalance \vec{U} and the corresponding machining depth h according to a geometrical relationship. For the correction hole 13 drilled from the curved section of the peripheral surface 12, the correction hole 13 can be dilled based on the machining depth h obtained therefrom. While for the correction hole 13 frilled from the reference plane 16, it is necessary to use the above formula to perform correction.

In one embodiment, referring to FIG. 9 and FIG. 10, N=2 is taken, and the corresponding two amount of unbalance \vec{U} are \vec{U₁} and \vec{U₂}. Both of the \vec{U₁} and \vec{U₂} are respectively located on two sides of the initial amount of unbalance \vec{U₀}. The angle between the amount of unbalance \vec{U₁} and the initial amount of inequality \vec{U₀} is set to be θ₁, and the angle between the amount of unbalance \vec{U₂} and the initial amount of unbalance \vec{U₀} is set to be θ₂. Values of the amount of unbalance \vec{U₁} and the amount of unbalance U₂ are determined according to the following equation:

$$\{ \begin{matrix}{U}_{1} = \frac{{U}_{0} sin {θ}_{2}}{sin ( {θ}_{1} + {θ}_{2} )} \\ {U}_{2} = \frac{{U}_{0} sin {θ}_{1}}{sin ( {θ}_{1} + {θ}_{2} )}\end{matrix}$$

Wherein, U₀ is the value of the amount of unbalance \vec{U₀}, U₁ is the value of the amount of unbalance \vec{U₁}, and U₂ is the value of the amount of unbalance \vec{U₂}.

In practice, there is a 70% chance that the initial amount of unbalance of the numerical control tool holder 11 will fall into the non-machinable angle range 18, so it is necessary to adopt the above mentioned way of changing the initial amount of unbalance \vec{U₀} into N amounts of unbalance and then machining the corrected holes separately.

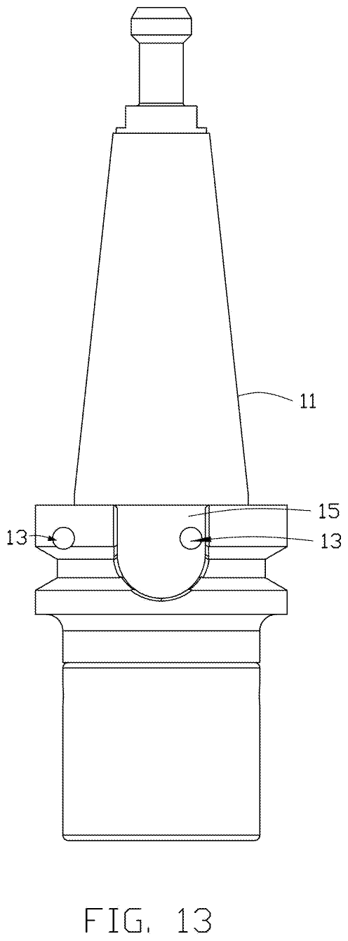

Referring to FIG. 13, embodiments of the present application also provide a numerical controlled tool holder 11. The numerical controlled tool holder 11 includes a tool holder body 14. A plurality of correction holes 13 are defined on the tool holder body. The plurality of correction holes 13 are machined by the rotary body dynamic balance detection and correction method as described above.

The numerical control tool holder 11 corrected by the dynamic balance detection and correction method has a high degree of dynamic balance, low transverse vibration during high-speed rotation, and high machining accuracy.

Even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

1. A rotary body dynamic balance detection and correction device, comprising:
a detection assembly, configuring for detecting an amount of unbalance of a rotary body; and
a machining correction assembly, configuring for machining and forming one or more correction holes on an outer peripheral surface of the rotary body, to make a value of the amount of unbalance of the rotary body do not exceed a predetermined value of a maximum amount of unbalance.

2. The rotary body dynamic balance detection and correction device as claimed in claim 1, wherein the rotary body is a numerical control tool holder, the detection assembly comprises an imitation computer numerical control (CNC) machine tool spindle, the imitation CNC machine tool spindle having a locking cylinder for clamping the numerical control tool holder, a dynamic balance measuring instrument is provided on the imitation CNC machine tool spindle, the dynamic balance measuring instrument is configured to measure the amount of unbalance of the numerical control tool holder when the imitation CNC machine tool spindle drives the numerical control tool holder to rotate.

3. The rotary body dynamic balance detection and correction device as claimed in claim 2, wherein the machining correction assembly comprises a machining head, a head displacement assembly, and a tool setting assembly, the machining head is mounted to the head displacement assembly, and the machining head is movable by the head displacement assembly to a position to be machined, the position to be machined locates at the outer peripheral surface of the numerical control tool holder clamped to the locking cylinder and corresponds to the machining head, the tool setting assembly is configured for a tool setting of the machining head.

4. The rotary body dynamic balance detection and correction device as claimed in claim 3, wherein the machining correction assembly further comprises a tool holder clamping assembly, the tool holder clamping assembly is configured for clamping the numerical control tool holder to limit a rotation of the numerical control tool holder.

5. A method of a dynamic balance detection and correction of a rotary body, comprising:
detecting a dynamic balance of the rotary body, to obtain an initial amount of unbalance \vec{U₀} of the rotary body; and
machining the rotary body for a correction, and machining a correction hole in an outer peripheral surface of the rotary body, wherein a value of an amount of unbalance of the rotary body after machining of the correction hole does not exceed a value of a predetermined maximum amount of unbalance.

6. The method as claimed in claim 5, wherein,
the outer peripheral surface of the rotary body includes a non-machinable angle range and a machinable angle range,
when the initial amount of unbalance \vec{U₀} is in the non-machinable angle range of the rotary body, N correction holes are machined in the machinable angle range of the rotary body, a vector sum of N amounts of unbalance \vec{U} corresponding to N correction holes is equal to the initial amount of unbalance \vec{U₀}, and N is an integer greater than or equal to 2.

7. The method as claimed in claim 6, wherein,
the rotary body is a numerical control tool holder, limiting grooves are defined on the outer peripheral surface of the numerical control tool holder, the limiting grooves are configured for rotatable mounting of the numerical control tool holder, bottom surfaces of the limiting grooves being reference planes,
N correction holes are formed by drilling inwardly along a radial direction of the numerical control tool holder by means of a ball drill bit, a process of forming N correction holes includes: determining a drilling depth h and a drilling angle θ of each of N correction holes according to a radius r₀ of the ball drill bit and an amount of unbalance \vec{U} corresponding to each of N correction holes, and
for a correction hole formed by drilling from the reference plane, the drilling angle θ is equal to an angle of the corresponding amount of unbalance \vec{U} of the correction hole formed by drilling from the reference plane, and the drilling depth h is calculated by following equations:
$$\{ \begin{matrix}R = \frac{L}{cos θ} \\ B = 4 {r}_{0} + 12 R \\ C = {r}_{0} ( {r}_{0} + 4 R ) \\ k = \frac{ρπ {r}_{0}^{2}}{12} \\ h = \frac{B - \sqrt{{B}^{2} - 24 ( C + U / k )}}{12}\end{matrix}$$
wherein, L is a distance from a axis center of the numerical control tool holder to the reference plane, r₀ is a radius of the ball drill bit, R is a distance from the axis center of the numerical control tool holder to an intersection of a radial line along the drilling angle θ and through the axis center of the numerical control tool holder and the reference plane, ρ is a density of a material of the numerical control tool holder, and U is a value of the amount of the unbalance \vec{U} corresponding to the correction hole formed by drilling from the reference plane.

8. The method as claimed in claim 7, wherein,
N=2, two corresponding amounts of unbalance \vec{U} are \vec{U₁} and \vec{U₂}, and both \vec{U₁} and \vec{U₂} are respectively located on two sides of the initial amount of unbalance \vec{U₀}, and the method further comprises:
setting an angle θ₁ between one of the two corresponding amounts of unbalance \vec{U₁} and the initial amount of unbalance \vec{U₀}, and setting an angle θ₂ between another one of the two corresponding amounts of unbalance \vec{U₂} and the initial amount of unbalance \vec{U₀}; and
determining values of the two corresponding amounts of unbalance \vec{U₁} and \vec{U₂} according to following equations:
$$\{ \begin{matrix}{U}_{1} = \frac{{U}_{0} sin {θ}_{2}}{sin ( {θ}_{1} + {θ}_{2} )} \\ {U}_{2} = \frac{{U}_{0} sin {θ}_{1}}{sin ( {θ}_{1} + {θ}_{2} )}\end{matrix}$$
wherein U₀ is the value of the amount of unbalance \vec{U₀}, U₁ is the value of the one of the two corresponding amounts of unbalance \vec{U₁}, and U₂ is the value of the other one of the two corresponding amounts of unbalance \vec{U₂}.

9. The method as claimed in claim 7, wherein,
if the correction hole formed by drilling from the reference plane by the ball drill bit along the drilling angle θ and a limiting groove coincide completely or do not coincide at all, then the drilling angle θ is a machinable angle, and a set consisting of all of the machinable angles constitutes the machinable angle range,
a range outside the machinable angle range is the non-machinable angle range.

10. A numerical control tool, comprising:
a tool holder body and a plurality of correction holes defined on the tool holder body, wherein the plurality of correction holes is processed by the method as claimed in claim 5.

11. The rotary body dynamic balance detection and correction device as claimed in claim 2, wherein, an internal structure of the imitation CNC machine tool spindle is symmetrical to minimize an unbalance error of a rotating portion.

12. The rotary body dynamic balance detection and correction device as claimed in claim 2, wherein,
the dynamic balance measuring instrument comprises an annular magnetic strip and a magnetic scale, the imitation CNC machine tool spindle is driven to rotate through a synchronous belt, the annular magnetic strip and the magnetic scale are configured for recording a real-time position of the tool holder.

13. The rotary body dynamic balance detection and correction device as claimed in claim 3, wherein,
the tool setting assembly comprises a tool setting moving assembly and a tool setting instrument, the tool setting instrument is mounted to the tool setting moving assembly, the tool setting instrument is movable relative to the machining head driven by the tool setting moving assembly to perform a tool setting operation.

14. The rotary body dynamic balance detection and correction device as claimed in claim 3, wherein,
the head displacement assembly comprises a moving mechanism, the moving mechanism comprises a horizontal bearing platform, a handwheel, a lead screw nut assembly, and a sliding guide, the horizontal bearing platform is arranged on the sliding guide, the handwheel controls the lead screw nut assembly to rotate, and position of the horizontal bearing platform can be adjusted up and down.

15. The rotary body dynamic balance detection and correction device as claimed in claim 3, wherein,
the machining head comprises a machining tool, a tool clamp, a machining rotary motor, and a machining feed motor, the machining tool is clamped in the tool clamp, the machining rotary motor is drive-connected to the tool clamp and rotates the machining tool via the tool clamp, the machining feed motor is drive-connected to the machining rotary motor and drives the machining rotary motor, the tool clamp, and the machining tool as a whole to move in a direction close to or away from the numerical control tool holder.

16. The method as claimed in claim 6, wherein, when the initial amount of unbalance \vec{U₀} is in the machinable range of the rotary body, one correction hole is machined on the rotary body according to the value and direction of the initial amount of unbalance \vec{U₀}.
